(19) United States
(12) Patent Application Publication
(10) Pub. No.: US 2025/0390680 A1
(43) Pub. Date: Dec. 25, 2025

(54) COMPUTER-IMPLEMENTED METHOD, COMPUTER PROGRAM PRODUCT AND COMPUTER SYSTEM FOR PROMPT PROCESSING

(71) Applicant: Accenture Global Solutions Limited, Dublin (IE)

(72) Inventors: Janardan MISRA, Bangalore (IN); Sanjay PODDER, Thane (IN)

(73) Assignee: Accenture Global Solutions Limited, Dublin (IE)

(21) Appl. No.: 19/233,712

(22) Filed: Jun. 10, 2025

(30) Foreign Application Priority Data
Jun. 25, 2024 (IN) 202411048712

(51) Int. Cl. G06F 40/30; G06F 40/40

(52) U.S. Cl. CPC G06F 40/30; G06F 40/40

(57) ABSTRACT

Methods, systems, and computer-readable storage media for processing a text prompt including a set of text Information Elements (IEs). Original instruction semantic IEs and original contextual IEs are identified within the text IEs. Some of the original instruction semantic IEs are identified for removal from the text prompt, based on semantic proximity values and internal consistency values of the instruction semantic IEs relative to first predefined criteria, while leaving surviving instruction semantic IEs. Similarly, some of the original contextual IEs are identified for removal from the text prompt due to weak connections with the surviving instruction semantic IEs and other of the contextual IEs based on second predefined criteria, while leaving surviving contextual IEs. Further, a revised text prompt corresponding to the surviving instruction semantic IEs and the surviving contextual IEs is generated and submitted as a query to a GAI system programmed to answer the query.

### CROSS-REFERENCE TO RELATED APPLICATIONS

This application claims priority to Indian Patent Application number 202411048712, filed on Jun. 25, 2024, entitled “COMPUTER-IMPLEMENTED METHOD, COMPUTER PROGRAM PRODUCT AND COMPUTER SYSTEM FOR PROMPT PROCESSING,” the entirety of which is hereby incorporated by reference.

### TECHNICAL FIELD

Various embodiments described herein relate generally to computer-implemented method, computer system, and computer program product for processing text prompts.

### BACKGROUND

Artificial Intelligence (AI) finds implementations in different use cases in the context of data processing. In the field of AI, Generative AI (GAI) has recently seen an explosion in popularity. GAI includes foundation models that generate a variety of content including, but not limited to, text, images, audio, and video based on training data. Examples of the foundation models include Large Language Models (LLMs), which are a form of GAI that can be used to generate text for a variety of use cases. In some examples, LLMs can be integrated in digital assistants (e.g., chatbots) replacing traditional rule-based systems to provide responses to inputs received from a user.

### SUMMARY

Implementations of the present disclosure are generally directed to optimization of text prompts and responses generated for the text prompts. More particularly, implementations of the present disclosure are directed to a processing system that enables identification and removal of irrelevant Information Elements (IEs) from text prompts in an energy efficient way. Thereby, overall energy/power consumption associated with prompt processing and response generation may be reduced.

In general, innovative aspects of the subject matter described in this specification provide a method for processing a text prompt including a set of Information Elements (IEs). The method includes identifying within the text IEs, original instruction semantic IEs and original contextual IEs. The method includes determining semantic proximity value and structural proximity value among the text IEs. Thereafter, for each of the original contextual IEs, the method incudes determining a semantic structural proximity value with each of the original instruction semantic IEs based on the semantic proximity value and structural proximity value between each of the original contextual IEs and each of the original instruction semantic IEs. For each of the original instruction semantic IEs, the method includes determining an internal consistency value. Upon determining the internal consistency value, the method includes identifying for removal of some of the original instruction semantic IEs based on the semantic proximity values and the internal consistency values relative to first predefined criteria, leaving surviving instruction semantic IEs. Similarly, the method includes identifying for removal of some of the original contextual IEs due to weak connections with the surviving instruction semantic IEs and the surviving contextual IEs. The method includes generating a revised text prompt corresponding to the surviving instruction semantic IEs and the surviving contextual IEs. Further, the method includes submitting the revised text prompt as a query to a Generative Artificial Intelligence (GAI) system programmed to answer the query.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 depicts an example environment that may be used to execute implementations of the present disclosure.

FIG. 2 depicts an example architecture of a processing system for processing text prompts in accordance with implementations of the present disclosure.

FIG. 3 depicts another example architecture of a processing system for processing text prompts in accordance with implementations of the present disclosure.

FIG. 4 is a block diagram that presents an example of an element identifier including components for identifying text Information Elements (IEs) within a text prompt in accordance with implementations of the present disclosure.

FIG. 5 is a block diagram that presents an example of a proximity detector including components for determining proximity values among the text IEs within the text prompt in accordance with implementations of the present disclosure.

FIG. 6 is a block diagram that presents an example of a consistency detector including components for determining internal consistency values of original instruction semantic IEs within the text prompt in accordance with implementations of the present disclosure.

FIG. 7 is a block diagram that presents an example of an element remover including components for removal of some of original instruction semantic IEs and original contextual semantic IEs within the text prompt in accordance with implementations of the present disclosure.

FIGS. 8, 9, and 10 depict an example illustration of processing the text prompt in accordance with implementations of the present disclosure.

FIG. 11 depicts an example illustration of identifying irrelevant IEs in the text prompt in accordance with implementations of the present disclosure.

FIG. 12 is a flow diagram that presents an example method for processing the text prompt including the text IEs in accordance with implementations of the present disclosure.

FIG. 13 illustrates a computer system that may be used to implement the processing system. Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ±5% may be expected. Non-numerical uses of “about” carry similar variation.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

With the advent of Generative Artificial Intelligence (GAI) systems, organizations are adopting the GAI systems to support execution of various processes throughout the organization. For example, a GAI system may support communications and interactions, and processes in software systems to support decision-making within the organizations. Multiple applications within a corporate network environment may use and interact with foundation models/Large Language Models (LLMs) of the GAI systems to provide input and/or data for the execution of a wide variety of tasks, such as, human computer interactions (i.e., question-answer), automating process execution, process planning, generating step-by-step procedures for the process execution, performing data analysis, and/or the like.

The foundation models/LLMs of the GAI system receive inputs primarily as text prompts. The text prompts may be in textual format including instructions and/or queries together with contextual information, which guides the GAI system for generating responses to the instructions and/or queries. Power consumption for the GAI system to processes a text prompt is driven by the semantics of the text prompt with respect to valuations of the underlying parameters. Simply stated, GAI processing of longer length text prompts consumes more power and requires more computer resources than processing of shorter length text prompts. Removal of content from the text prompt that does not meaningfully contribute to the response provided by the GAI system would reduce both power consumption and consumed computer resources of the GAI.

Further, for semantic queries, the LLMs may provide accurate responses when the text prompts further include relevant contextual information. For example, a text prompt with contextual information: “Suggest a Python API for matrix inversion with mixed precision support” may result into more precise and relevant response as compared to a text prompt with less contextual information: “Suggest a Python API for matrix inversion”. Responses generated by the LLMs based on suboptimal context of their application scenario tend to cause the user to resubmit variations of the text prompts, which leads to repeated executions of the entire prompt lifecycle with corresponding increase in overall computational cost and power requirements of prompt processing.

According to implementations of embodiments of the present disclosure, the overall power consumption of the prompt lifecycle is reduced by identifying and removing irrelevant Information Elements (IEs) from the text prompt before processing submission of the GAI system; shortening the text prompt via the removal of the irrelevant IEs reduces the power required by the GAI system to process the text prompt. Also, removing of the irrelevant IEs may reduce reiterations due to re-prompting with corresponding power savings.

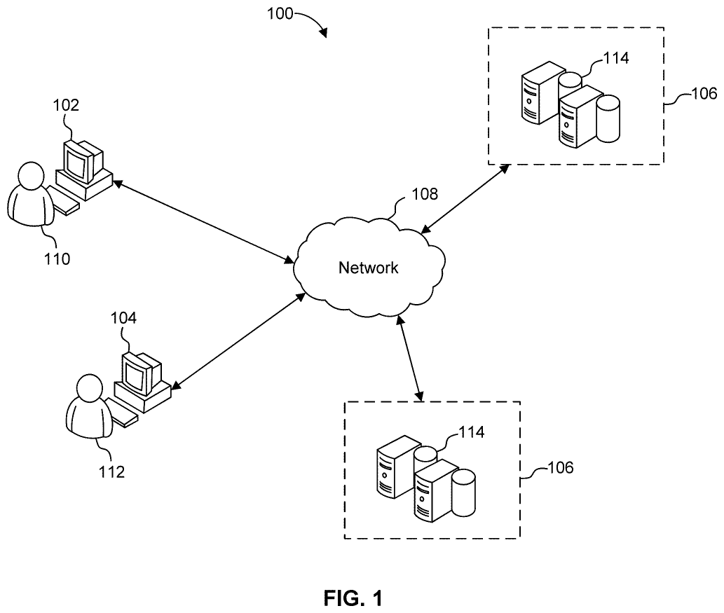

FIG. 1 depicts an example environment 100 that may be used to execute implementations of the present disclosure. In some examples, the example environment 100 enables processing of a text prompt being inputted by a user(s) associated with a respective system for one or more responses.

As depicted in FIG. 1, the example environment 100 includes computing devices 102 and 104, back-end systems 106, and a network 108. In some examples, the computing devices 102 and 104 are used by respective users 110 and 112 to log into and interact with computing platforms executing applications according to implementations of the present disclosure. Examples of the computing devices 102 and 104 may include desktop computing devices, smartphones, laptops, tablet, voice-enabled devices, and/or the like. It is contemplated that implementations of the present disclosure may be realized with any appropriate type of computing device. In some examples, each of the computing devices 102 and 104 may include a web browser application executed thereon, which may be used to display one or more web pages of a computing platform executing applications. In some examples, each of the computing devices 102 and 104 may display one or more Graphical User Interfaces (GUIs) that enable the respective users 110 and 112 to interact with the computing platform.

In some examples, the network 108 may include a Local Area Network (LAN), a Wide Area Network (WAN), the Internet, or a combination thereof, and connects web sites, the computing devices 102 and 104, and the back-end systems 106. In some examples, the network 108 may be accessed over a wired and/or a wireless communication link. For example, a computing device like smartphone may utilize a cellular network to access the network 108.

In some examples, one or more of the back-end systems 106 may be implemented as an on-premises system that is operated by an enterprise or a third-party engaged in cross-platform interactions and data management. In some examples, the back-end systems 106 may be implemented as an off-premises system (for example, cloud or on-demand) that is operated by an enterprise or a third-party on behalf of an enterprise. In some examples, the back-end systems 106 may be implemented in a cloud environment. For simplicity, the back-end systems 106 depicted in FIG. 1 may be a cloud environment that is intended to represent various forms of servers including a web server, an application server, a proxy server, a network server, a server pool, and/or the like.

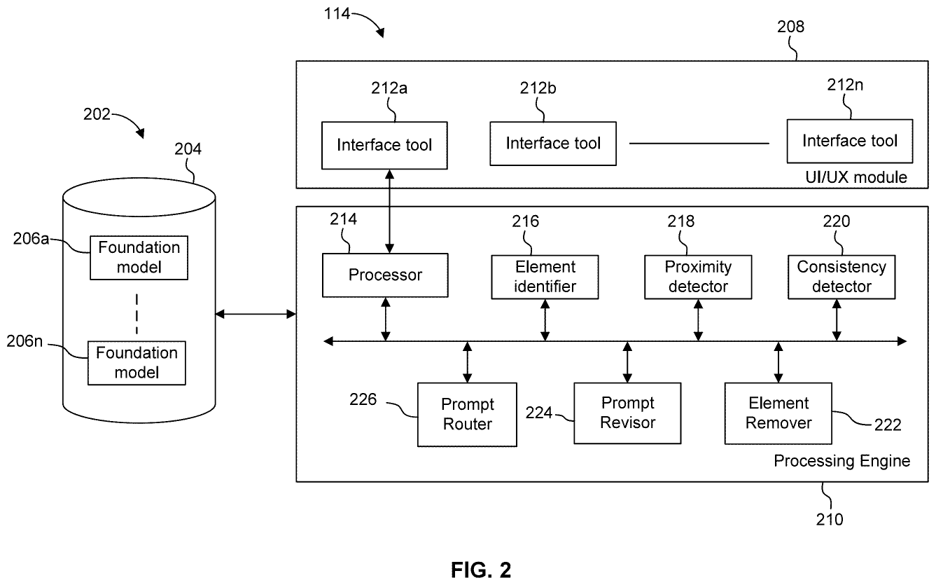

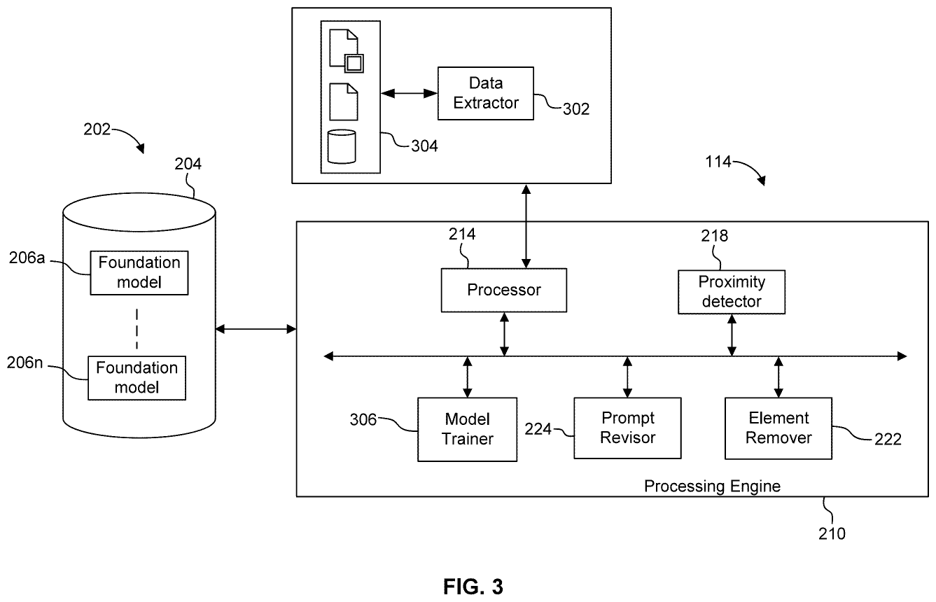

In some examples, each of the back-end systems 106 includes one or more processing systems 114. A processing system may host components of enterprise systems and applications. Also, the processing system 114 accepts requests from the users 110 and 112 through the respective computing devices 102 and 104 for services being provided by the enterprise systems and the applications. In response to the accepted requests, the processing system 114 provides the requested services to the computing devices 102 and 104 over the network 108. The requests received from the users 110 and 112 through the respective computing devices 102 and 104 may be text prompts. The text prompts may be used as a mode of interaction with a Generative Artificial Intelligence (GAI) system (as depicted in FIGS. 2 and 3). In some examples, the GAI system may be implemented by the enterprise systems for generating responses/outputs for the text prompts or for performing one or more specified tasks in response to the text prompts. Examples of the tasks may include question-answering, automation of process execution, process planning, generation of step-by-step procedures, performing of data analysis, and/or the like.

According to implementations of the present disclosure, the processing system 114 may be adapted for processing the text prompts, before submitting the text prompts as queries for the GAI system. Various examples depicting the processing of the text prompts are described in detail in conjunctions with figures below.

FIG. 2 depicts an example architecture of a processing system 114 for processing the text prompts in accordance with implementations of the present disclosure. In an example, as depicted in FIG. 2, the text prompts may be referred to requests, user inputs, and/or the like, received from a user through a respective computing device. The text prompts may be pertaining to the one or more tasks that may be executed by the GAI system 202.

In some examples, the GAI system 202 generates content/responses such as, but are not limited to, text, images, audio, video, and/or the like, for the text prompt. Alternatively, the generated content/responses may correspond to one or more of the tasks being executed by the GAI system 202. The GAI system 202 includes a hosting infrastructure 204 to host one or more foundation models 206a-206n. The hosting infrastructure 204 represents technical infrastructure(s), where the foundation models 206a-206n are hosted. Examples of the hosting infrastructure 204 may include cloud computing platforms or the like.

In some examples, the foundation models 206a-206n may be provided by one or more third parties. In some examples, the foundation models 206a-206n may be provided by one or more enterprises deployed the processing system 114. A foundation model 206a-206n receives requests/queries and provide responses to the processing system 114 of the present disclosure. For example, requests/queries may be received as processed text prompts through an Application Programming Interface (API).

The foundation model 206a-206n may be described as a general-purpose GAI model like large deep learning neural network. The large deep learning neural network may be trained using a broad range of generalized, unlabeled training data and that may perform a multitude of general tasks. Examples of the tasks may include generating text, generating images, conversing in natural language, generating video, generating audio, and/or the like. In some examples, the applications may be built on top of the foundation models. In some examples, multiple foundation models may be used to perform a range of functionality for an application.

The foundation models 206a-206n may include, for example, Large Language Models (LLMs), which are a form of GAI that may be used to generate text for a variety of use cases. In some examples, the LLMs may be integrated in digital assistants (for example, chatbots), replacing traditional rule-based systems to provide textual responses to a user input. A LLM may be described as an advanced type of language model that is trained using deep learning techniques on massive amounts of text data. The text data is general and not specific to any particular domain. A LLM may described as an advanced type of language model that is trained using deep learning techniques on massive amounts of text data. The text data is general and not specific to any particular domain. The LLMs may generate human-like text and perform various Natural Language Processing (NLP) tasks (for example, translation, question-answering, and/or the like). In some examples, the LLM refers to models that use deep learning techniques and have a plurality of parameters, which may range from millions to billions. The LLMs may capture complex patterns in language and produce text that is often indistinguishable from that written by humans. The produced text may be processed through a deep learning architecture such as, recurrent neural network (RNN), a transformer model, and/or the like.

While implementations of the present disclosure are described in further detail herein with non-limiting reference to the LLMs as the example foundation models, it is contemplated that implementations of the present disclosure may be realized using any appropriate foundation models or Machine Learning (ML) models, or Artificial Intelligence (AI) models. Such models may generate the content/response based on any appropriate modality (for example, text, audio, image, video, and/or the like). In some examples, the response may correspond to one or more of the tasks being represented by the text prompt.

As depicted in FIG. 2, the processing system 114 includes a User Interface (UI)/User Experience (UX) module 208 and processing engine 210.

In some examples, the UI/UX module 208 may represent one or more front-end components/interfaces 212a-212n of a chatbot that may be executed on one or more of the computing devices 102-104 to enable receipt of the text prompt and providing one or more responses to the text prompt. In some examples, the text prompt may be received through various modalities including, but not limited to, a question input to a chat bot, a request provided through a Graphical User Interface (GUI), an email, and/or the like.

The text prompt includes a set of text Information Elements (IEs). Each text IE may be a sentence of the text prompt. In some examples, the text IEs may provide instructions and/or contextual information to the foundation models/LLMs 206a-206n of the GAI system 202 to perform the tasks.

The processing engine 210 may be configured for processing the text prompt received through the UI/UX module 208. The processing engine 210 includes one or more processors 214, an element identifier 216, a proximity detector 218, a consistency detector 220, an element remover 222, a prompt revisor 224, and a prompt router 226.

The processor 214 may include, for example, microprocessors, microcomputers, microcontrollers, digital signal processors, central processing units, state machines, logic circuits, and/or any devices that manipulate data or signals based on operational instructions. Among other capabilities, the processor 214 may fetch and execute computer-readable instructions in a memory operationally coupled with the processing system 114 for processing the text prompt. Any reference to a task in the present disclosure may refer to an operation being or that may be performed on the text prompt.

In an example, as depicted in FIG. 2, the processor 214 may be coupled to the element identifier 216, the proximity detector 218, the consistency detector 220, the element remover 222, the prompt revisor 224, and the prompt router 226.

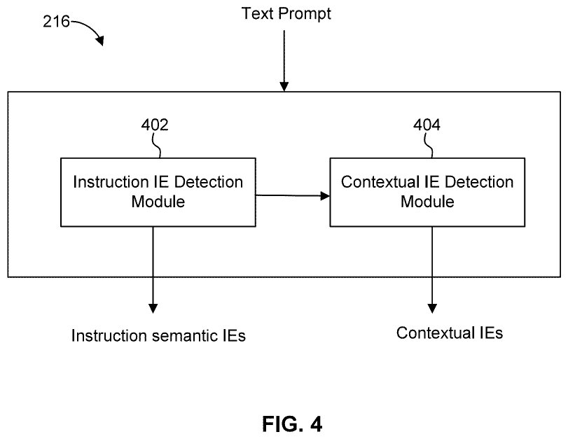

The element identifier 216 may identify original instruction semantic IEs and original contextual IEs within the text IEs of the text prompt. The term “original” referred herein may indicate as received in the text prompt. The original instruction semantic IEs may include instruction and/or interrogative sentences representing one or more of the tasks to be performed by the foundation models/LLMs 206a-206n of the GAI system 202. Examples of the original instruction semantic IEs may include “Summarize below text”, “Explain the concept of language modeling”, “What is theorem A?”, and/or the like. The original contextual IEs may include contextual sentences providing context/additional information for the original instruction semantic IEs or context for performing one or more of the tasks represented by the original instruction semantic IEs. The element identifier 216 is described in detail in conjunction with FIG. 4.

Upon identifying the text IEs within the text prompt, the proximity detector 218 may determine semantic proximity value and structural proximity value among the text IEs. The semantic proximity value may represent closeness in meaning between two text IEs of the text prompt. The structural proximity value may represent a physical proximity between the two text IEs of the text prompt (i.e., colocation of the two text IEs).

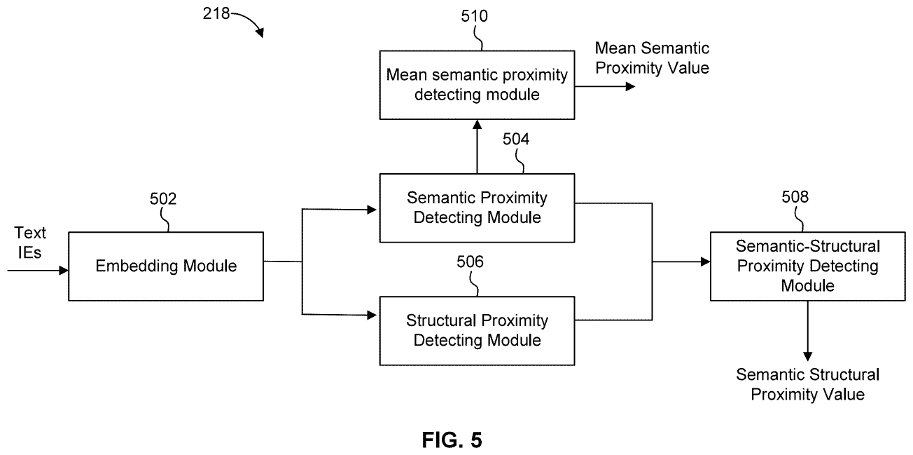

Further, for each of the original instruction semantic IEs, the proximity detector 218 may determine a semantic structural proximity value with each of the original instruction semantic IEs based on the semantic proximity value and structural proximity value between each of the original contextual IEs and each of the original instruction semantic IEs. The semantic structural proximity value between the two text IEs is a weighted combination of the semantic proximity value and the structural proximity value between the two text IEs. The proximity detector 218 is descried in detail in conjunction with FIG. 5.

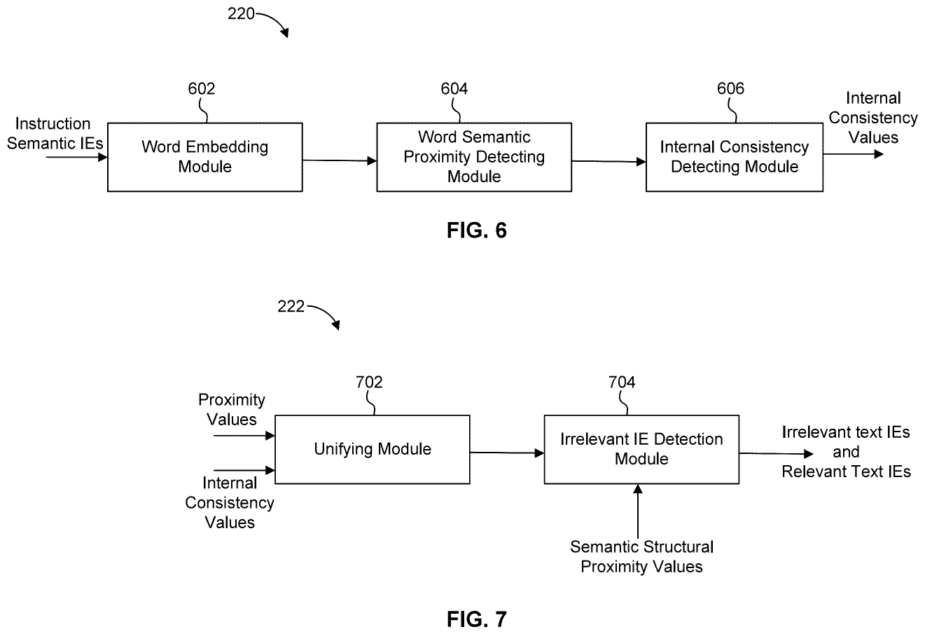

The consistency detector 220 may determine for each of the original instruction semantic IEs, an internal consistency value. The internal consistency value of a particular IE may be based on semantic proximities among constituent word pairs within the particular IE. The consistency detector 220 is descried in detail in conjunction with FIG. 6.

The element remover 222 may identify for removal of some of the original instruction semantic IEs based on the semantic proximity values and the internal consistency values relative to first predefined criteria, leaving surviving instruction semantic IEs. Hereinafter, some of the original instruction semantic IEs identified for removal may be referred to as irrelevant instruction semantic IEs. The irrelevant instruction semantic IEs may have weak connections (i.e., not semantically proximate) with the other text IEs within the text prompt and inconsistent within the text prompt. Similarly, the surviving instruction semantic IEs may be referred to as relevant instruction semantic IEs. The surviving instruction semantic IEs may have strong connections (i.e., semantically proximate) with the other text IEs within the text prompt and consistent within the text prompt.

The element remover 222 may further identify for removal of some of the original contextual information IEs due to weak connections with the surviving instructions semantic IEs and others of the contextual information IEs based on second predetermined criteria, leaving surviving contextual IEs. Hereinafter, some of the original contextual IEs identified for removal may be referred to as irrelevant contextual IEs. The irrelevant contextual IEs may have weak connections with respect to the surviving instruction semantic IEs. Similarly, the surviving instruction semantic IEs may be referred to as relevant instruction semantic IEs. The surviving contextual IEs may have strong connections with the surviving contextual IEs. The irrelevant instruction semantic IEs and the irrelevant contextual IEs may be collectively referred to as irrelevant text IEs.

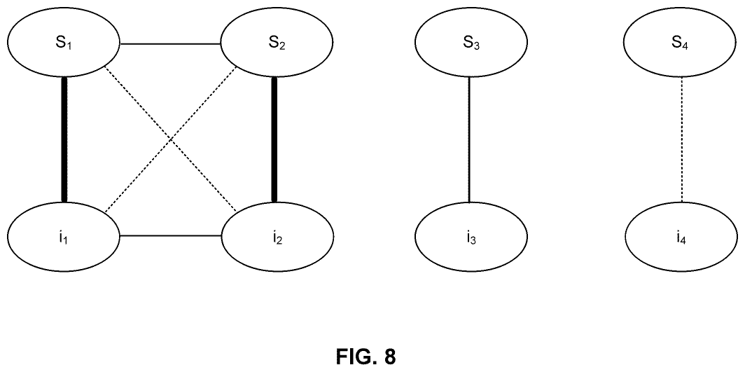

The element remover 222, the first predefined criteria, and the second predetermined criteria are described in detail in conjunction with FIG. 7.

The prompt revisor 224 may generate a revised text prompt. The prompt revisor 224 may generate the revised text prompt by removing some of the original instruction semantic IEs and some of the original contextual IEs identified for the removal by the element remover 222. Thereby, the revised text prompt corresponds to the surviving instruction semantic IEs and the surviving contextual information IEs without the irrelevant instruction semantic IEs and the irrelevant contextual information IEs.

The prompt router 226 may submit the revised text prompt as a query to the GAI system 202 programmed to answer the query. Submitting the revised text prompt as the query to the GAI system 202 may involve submitting the revised text prompt as the query to one or more of the foundation models/LLMs 206a-206n of the GAI system 202. As the revised text prompt includes only the surviving instruction semantic IEs and contextual IEs, the LLM may generate the response/answer for the query while consuming less computational resources and energy as compared to the original text prompt.

Consider an example scenario, wherein the below relationship may hold between energy consumption during the response/answer generation (i.e., during inference process) by the LLM:

$$Energy ( N ) = ( 0.000007 \times N + 0.0004 ) kiloWatthour ( KWh )$$

In such a scenario, substantial reduction in the size of the text prompt may result in reduction in energy (for example, 15.6% reduction in energy) while considering that a number of tokens in the text prompt may be on average N=200.

FIG. 3 depicts another example architecture of the processing system 114 for processing the text prompts in accordance with implementations of the present disclosure. In an example, as depicted in FIG. 3, the text prompts may be referred to elements of datasets, which are used for training the foundation models/LLMs 206a-206n of the GAI system 202. With reference to the example depicted in FIG. 3, the text prompts may include datapoints of a single dataset or one or more datasets of multiple datasets. Each dataset may include training data-points for training the foundation models/LLMs 206a-206n.

In some examples, the processing system 114 may include a data extractor 302. The data extractor 302 may extract the datasets from variety of data sources, for example, such as the data sources 304. In some examples, the data sources may include databases maintained by external parties or the enterprise/organizations hosting the processing system 114.

Similar to FIG. 2, the processing engine 210 of the processing system 114 may process the text prompt, which includes the datapoints or the one or more datasets. Some of the components of the processing engine 210 as depicted in FIG. 2 may be used to process the text prompt. The components may include the proximity detector 218, the element remover 222, and the prompt revisor 224.

It should be noted that the text prompt including the datapoints or the datasets may be processed without identifying the text IEs within the text prompt, since the instruction semantic IEs are not considered for the datapoints or the datasets. Therefore, processing the text prompt including the datapoints or the datasets may not require estimation of the internal consistency as well. Due to which the element identifier 216 and the consistent detector 220 may be disabled while processing of the text prompt including the datapoints or the datasets.

In some examples, if the text prompt includes the datapoints, all the datapoints of the text prompt may be considered within an unlabeled training dataset as the text IEs. Further, irrelevant datapoints (i.e., the irrelevant text IEs) may be identified for removal from the text prompt and accordingly the revised text prompt may be generated from the text prompt using the proximity detector 218, the element remover 222, and the prompt revisor 224.

In some examples, if the text prompt includes the datasets derived from a collection (or corpus) of the multiple datasets, all the datapoints within each dataset may be collectively considered as the text IE. Further, irrelevant datapoints (i.e., the irrelevant text IEs) in the multiple datasets may be identified for removal from the text prompt and accordingly the revised text prompt may be generated using the proximity detector 218, the element remover 222, and the prompt revisor 224.

The components such as the proximity detector 218, the element remover 222, and the prompt revisor 224, are already described in conjunction with FIG. 2, therefore repeated description is omitted herein for sake of brevity.

Still referring to FIG. 3, the processing engine 210 may further include model trainer 306 for training the foundation models/LLMs 206a-206n. The model trainer 306 may use the text prompt revised according to example of FIG. 3 for training of the foundation models/LLMs 206a-206n.

FIG. 4 is a block diagram that presents an example of the element identifier 216 including components for identifying the text IEs within the text prompt in accordance with implementations of the present disclosure. The element identifier 216 may receive the text prompt and identify the text IEs including the original instruction semantic IEs and the original contextual IEs in the text prompt.

The text prompt includes the set of IEs, wherein each IE represents one or more text sentences. In some examples, each text sentence may be unique. In some examples, there may be one or more duplicate/repetitive text sentences. In such a scenario, only one of the duplicate sentences of a first presence in the text prompt may be considered.

For example, the text prompt may be represented as:

$${P}_{r} = \{ {S}_{1} , {S}_{2} , ... ... ... ... ... .. , {S}_{n} \}$$

wherein, each of ‘S₁, S₂, . . . , Sₙ’ represents the text IEs of the text prompt ‘Pᵣ’. Further, . . . . Sₙ′ appear in a sequential order within the text prompt ‘Pᵣ’. Furthermore, for the IE ‘sᵢ’, ‘i’ is an index within the text prompt ‘Pᵣ’ such that a function ‘in(s)’ returns index of the IE s∈Pᵣ and i≥1.

The element identifier 216 includes an instruction IE detection module 402 and a contextual IE detection module 404 for identifying the text IEs within the text prompt.

The instruction IE detection module 402 may identify the original instruction semantic IEs in the text prompt. In some examples, the original instruction semantic IEs may include interrogative or instructive IEs, which may involve one or more actionable verbs. Specifically, the instructive IEs may represent one or more of the goals/tasks to be achieved. For example, an original instruction semantic IE may be a subset of the text sentences in the text prompt ‘Pᵣ’ and represented as Iₛ⊆Pᵣ.

In some examples, the original instruction semantic IEs may include “How high is Mt. A in Country A?”, “How many people visit Mt. A in Country A?”, “How many people are in Country A?”, and/or the like.

The instruction IE detection module 402 may identify the original instruction semantic IEs using any suitable Natural Language Processing (NLP) methods. In some examples, the instruction IE detection module 402 may identify the original instruction semantic IEs including the interrogative IEs using sentence parsing methods. The sentence parsing methods may involve identifying the interrogative sentences through clause level tags like Simple declarative clause (SBARQ) or Simple clause (SQ). In some examples, the original instruction IE detection module 402 may identify the original instruction semantic IEs including the instructive IEs using intent identification methods. It is contemplated that implementations of the present disclosure may use any appropriate methods to identify the instruction semantic IEs.

The contextual IE detection module 404 may identify the original contextual IEs in the text prompt. The text IEs remaining after the identification of the original instruction semantic IEs may be referred to as the original contextual IEs. The original contextual IEs provide contextual/complementary details for one or more of the foundation models 206a-206n, while generating a response for the text IEs of the text prompt. For example, a contextual IE (C) may be represented as C=Pᵣ/Iₛ.

In some examples, the original contextual IE may include “Mt. stands for Mountain” for the original instruction semantic IE “How high is Mt. A in Country A” present in the text prompt.

FIG. 5 is a block diagram that presents an example of the proximity detector 218 including components for determining proximity values among the IEs within the text prompt in accordance with implementations of the present disclosure. The proximity values may include the semantic proximity value, the structural proximity value among the text IEs within the text prompt, the semantic structural proximity value of each original contextual IE, and a mean semantic proximity value of each original instruction semantic IE.

The proximity detector 218 includes an embedding module 502, a semantic proximity detecting module 504, a structural proximity detecting module 506, a semantic-structural proximity detecting module 508 and a mean semantic proximity detecting module 510.

The embedding module 502 may receive the text IEs including the original instruction semantic IEs and the original contextual IEs and map each text IE onto an embedding space as a vector (hereinafter referred to as embedded vector). For example, a set of embedding vectors of each text IE={S₁, S₂, . . . , Sₙ} may be represented as Eₚᵣ={es₁, . . . esₙ}.

In some examples, the embedding module 502 may map each IE onto the embedding space. Each IE may be mapped onto the embedding space, by way of non-limiting example, using SIAMESE-BERT network as known in the art and not further discussed herein. The embedding module 502 may provide the set of embedding vectors of each text IE to the semantic proximity detecting module 504.

The semantic proximity detecting module 504 may determine the semantic proximity value among each pair of the text IEs using the set of embedding vectors of the text IEs. The semantic proximity value between the two text IEs may identify whether the two text IEs are semantically proximity with each other or not (i.e., having identical meaning or not) or having strong connections with each other or not.

In some examples, the semantic proximity value may be determined as:

$${Sem}_{pr} : {E}_{pr} \times {E}_{pr} ↦ [ - 1 , 1 ]$$

wherein, ‘Semₚᵣ’ represents the semantic proximity value/measure between each pair of embedding vectors of the text IEs. Further, ‘Sem’ may be implemented in multiple ways. In accordance with the implementations of the present disclosure, ‘Sem’ may be implemented as Cosine function. In some examples, if the semantic proximity value between the text IEs ‘s’ and ‘s′’ is 1 (i.e., Sem(es, es′):1), then it implies that the text IEs ‘s’ and ‘s′’ are semantically proximate to each other or having strong connections with each other (i.e., the text IEs ‘s’ and ‘s′’ are having identical meaning). Similarly, if the semantic proximity value between the text IEs ‘s’ and ‘s′’ is −1 (i.e., Sem(es, es′):−1), then it implies that the text IEs ‘s’ and ‘s′’ are semantically opposite or having weak connections with each other (i.e., the text IEs ‘s’ and ‘s′’ are having opposite meaning). Therefore, the semantic proximity value between the text IEs may vary between ‘+1’ and ‘−1’ representing the connections between the text IEs in terms of meaning.

Consider an example scenario, wherein first and second instruction semantic IEs such as “How high is Mt. A in Country A” and “explain how to climb Mt. A” are identified along with the contextual IE “Mt. stands for Mountain”. In such a scenario, the semantic proximity detecting module 504 may measure that the two instruction semantic IEs are closer/semantically proximate with each other than a second instruction semantic IE to the contextual IE.

After determining the semantic proximity value between the text IEs within the text prompt, the structural proximity detecting module 506 may determine the structural proximity value between the text IEs within the text prompt.

The structural proximity value between the text IEs may measure how closely located are the text IEs within the text prompt. More specifically, the structural proximity value between the two text IEs may represent a distance between the two text IEs from each other in the text prompt. For example, if the text IEs are spaced further apart (i.e., a distance between the text IEs is high) in the text prompt, then the structural proximity between the text IEs may be less likely related. Alternatively, if the text IEs are closely spaced (i.e., a distance between the text IEs is less) in the text prompt, then the structural proximity between the text IEs may be highly related with each other. Therefore, the text IEs that are co-located may be considered having higher structural proximity value over the text IEs that are located far apart within the text prompt.

In some examples, the structural proximity value (strProx(s, s′)) may be determined as:

$$strProx ( s , {s}^{′} ) = \frac{1}{\vert in ( s ) - in ( {s}^{′} ) \vert + 1}$$

Consider an example scenario, wherein first and second instruction semantic IEs such as “How high is Mt. A in Country A” and “explain how to climb Mt. A” are identified along with the contextual IE “Mt. stands for Mountain”. In such a scenario, the structural proximity detector module 506 may determine that the first instruction semantic IE may be closer/structurally proximate to the second instruction semantic IE than the first instruction semantic IE to the contextual IE.

Semantic proximity values and Structural proximity values among all the pair of the text IEs (as determined above) may be provided to the semantic-structural proximity detecting module 508.

The semantic-structural proximity detecting module 508 may determine the semantic structural proximity value for each of the original contextual IEs. The semantic-structural proximity detecting module 508 may determine the semantic structural proximity value based on the semantic proximity value and the structural proximity value between each of the original contextual IEs and each of the original instruction semantic IEs.

Consider an example scenario, wherein first and second instruction semantic IEs such as “How high is Mt. A in Country A” and “explain how to climb Mt. A” are identified along with the contextual IE “Mt. stands for Mountain”. In such a scenario, the semantic-structural proximity detecting module 508 may determine a first semantic structural proximity value between the contextual IE and the first instruction semantic IE and a second semantic structural proximity value between the contextual IE and the second instruction semantic IE.

In some examples, the semantic structural proximity value may be determined as:

$$SemStr ( s , i ) = \partial * strProx ( s , i ) + ( 1 - \partial ) * Sem ( s , i )$$

wherein, ‘∂’∈[0,1] represents a relative significance between the semantic and structural proximities among the original contextual and instruction semantic IEs of the text prompt. For example, the original contextual IEs that are semantically related and are also co-located within the text IE may have the highest semantic structural proximity value. Further, ‘d’ may be either specified by an operating environment or may be represented as:

$$\partial = \{ \begin{matrix}0 & if n = 1 \\ \frac{n}{100} & if n < 50 \\ 0.5 & if n > 50\end{matrix}$$

wherein, ‘n’ represents a size of the text prompt (i.e., a number of text IEs/tokens present in the text prompt). The semantic structural proximity value may gain high significance as the size of the text prompt increases. However, the sematic structural proximity value may have its maximum value at 0.5 after the size of the text prompt becoming too large (for example, more than 50 sentences). Therefore, the text prompt with lower number of text IEs may have low impact on the semantic structural proximity value and the text prompt with higher number of IEs may have high impact on the semantic structural proximity value due to larger distances between the number of text IEs.

The mean semantic proximity detecting module 510 may determine a mean semantic proximity value for each original instruction semantic IE (Iₛ) with respect to all other original instruction semantic IEs (Iₛ′) in the text prompt (Pᵣ). For example, the mean semantic proximity value (Δ_{II}(Iₛ)) of the original instruction semantic IE (Iₛ) may be determined as:

$${Δ}_{II} ( {P}_{r} ) = \frac{{\sum }_{{{I}_{s}}^{′} ∈ I} Sem ( {I}_{s} , {{I}_{s}}^{′} )}{\vert {P}_{r} \vert}$$

wherein, ‘Sem(Iₛ, Iₛ′)’ represents a semantic proximity value between the original two instruction semantic IEs ‘Iₛ’ and ‘i′’.

Considering an example scenario, where first and second instruction semantic IEs such as “How high is Mt. A in Country A” and “explain how to climb Mt. A” are identified along with the contextual IE “Mt. stands for Mountain”. In such a scenario, a mean semantic proximity of the instruction semantic IE may be determined with respect to the second instruction semantic IE.

The various proximity values as described above may be used for identifying at least some of the irrelevant instruction semantic IEs and contextual IEs in the text prompt, which is described in detail in conjunction with FIG. 7.

FIG. 6 is a block diagram that presents an example of the consistency detector 220 including components for determining the internal consistency value in accordance with implementations of the present disclosure. The consistency detector 220 includes a word embedding module 602, a word semantic proximity detecting module 604, and an internal consistency detecting module 606.

The word embedding module 602 may identify words in the instruction semantic IEs that are non-language stop words. The words may be identified based on an available list of stop words, which may be obtained from different data sources. Alternatively, the words may be identified based on pre-defined non-language stop words. Consider an example instruction semantic IE as “please provide a list of primes less than 1000”. In such an IE, stop words to be removed may include “of” and “than” and other remaining words in the IE may be identified as the non-language stop words.

The word embedding module 602 may further map each of the identified words into an embedding space as a vector (referred to as an embedding vector). Each of the identified words may be mapped into the embedding space by way of non-limiting example, using global vector representations as known in the art and not further discussed herein.

The semantic proximity detecting module 604 may estimate a semantic proximity between the words in the original instruction semantic IEs using the embedding vector of each of the words. The semantic proximity between the words may be calculated by way of non-limiting example, using a Cosine calculation method as known in the art and not further discussed herein.

The internal consistency detecting module 606 may determine the internal consistency value (also be referred to as semantic consistency value) for each of the original instruction semantic IEs. The internal consistency determined for an original instruction semantic IE may represent a degree of consistency or semantic proximities among all its constituent word pairs.

The internal consistency detecting module 606 may determine the internal consistency value of each original instruction semantic IE as an average of the semantic proximities determined among all the constituent word pairs within the respective original instruction semantic IE. For example, the internal consistency (inCon(Iₛ)) of the original instruction semantic IE (Iₛ) may be determined as:

$$inCon ( {I}_{s} ) = \frac{{\sum }_{( w , w ′ ) ∈ {I}_{s}} Sem ( w , {w}^{′} )}{{\vert n \vert}^{2}}$$

wherein, ‘Sem(w, w′)’ represents the semantic proximity between the words in the original instruction semantic IE and ‘n’ represents a number of words in the original instruction semantic IE.

Internal consistency values of all the original instruction semantic IE (as determined above) may be used to identify the irrelevant instruction semantic IEs in the text prompt, which is described in detail in conjunction with FIG. 7.

FIG. 7 is a block diagram that presents an example of the element remover 222 including components for removal of at least some of the original instruction semantic IEs and the original contextual semantic IEs within the text prompt in accordance with implementations of the present disclosure.

The element remover 222 includes a unifying module 702, an irrelevant IE detection module 704, and a removal module 706.

The unifying module 702 may determine an overall semantic relevance score for each of the original instruction semantic IEs within the text prompt. The semantic relevance score of the original instruction semantic IEs may be determined based on the semantic proximity value among the original instruction semantic IEs and the internal consistency values of the original instruction semantic IEs.

In some examples, the semantic relevance ‘semRel(Iₛ)’ of the original instruction semantic IE ‘Iₛ’ in the text prompt (Pᵣ) as:

$$semRel ( {I}_{s} ) = ε * {Δ}_{II} ( {I}_{s} ) + ( 1 - ε ) * inCon ( {I}_{s} )$$

wherein, ε∈[0,1] may be a weighing factor between the semantic proximities among the original instruction semantic IEs and the internal consistency values of the original instruction semantic IEs. In some examples, ‘ε’ may be defined in accordance with an operating environment. In some examples, ‘ε’ may be assigned with a default value of ‘0.7’. In some examples, ε=1, if the text prompt includes the datapoints of the datasets for training of the foundation models/LLMs 206a-206n.

Consider an example scenario, wherein the original instruction semantic IEs are semantically proximate to each other and are inconsistent with each other. In such a scenario, the semantic relevance score may be low. Consider another example scenario, wherein the original instruction semantic IEs are not semantically proximate to each other and are consistent with each other. In such a scenario, the unified semantic relevance score may be low. Consider yet another example scenario, wherein the original instruction semantic IEs are semantically proximate to each other and are consistent with each other. In such a scenario, the semantic relevance score may be high.

The irrelevant IE detection module 704 may identify some of the original instruction semantic IEs and the original contextual IEs as irrelevant (i.e., the irrelevant instruction semantic IEs and the irrelevant contextual IEs).

For identifying the irrelevant instruction semantic IEs, the irrelevant IE detection module 704 may determine an ordering of the original instruction IEs in the text prompt based upon their semantic relevance scores. For example, the ordering of the original instruction semantic IEs may be represented as sᵢ_{₁}, sᵢ_{₂}, . . . , sᵢ_{_{|I|}} with respect to their semantic relevance scores semRel(sᵢ_{₁})≥semRel(sᵢ_{₂})≥ . . . semRel(sᵢ_{_{|I|}}).

Based upon the ordering, the irrelevant IE detection module 704 may identify the irrelevant instruction semantic IEs according to the first pre-determined criteria. For example, the first pre-determined criteria may represent a pre-defined percentage X or a pre-defined threshold Z.

In some examples, the irrelevant IE detection module 704 may identify some of the original instruction semantic IEs as the irrelevant instruction semantic IEs, which are ordered below the pre-defined percentage X. Alternatively, the irrelevant IE detection module 704 may identify some of the original instruction semantic IEs as the irrelevant instruction semantic IEs, which are having the semantic relevance score less than the pre-defined threshold Z.

In some examples, the percentage X and the pre-defined threshold Z may set in accordance with an operating environment. For instance, the percentage X and the threshold Z may set as 10 and 0.1 respectively. In some examples, the percentage X may set using Likert Scale as high (>80), moderate (50-80), and low (<50). Similarly, the threshold Z may set using Likert Scale as high (>0.8), moderate (0.5-0.8), and low (<0.5). In such a scenario, the high scale of the percentage X and the pre-defined threshold Z may indicate to remove more instruction semantic IEs than the moderate and low scale of the percentage X and the pre-defined threshold Z.

Consider an example scenario, wherein the text prompt includes five instruction semantic IEs (Iₛ−1, Iₛ−2, Iₛ−3, Iₛ−4 and Iₛ−5) and semantic scores of the five instruction semantic IEs are estimated as 0.13, 0.47, 0.34, 0.59, and 0.64, respectively. In such a scenario, the five instruction semantic IEs are ordered in a sequence in accordance with their semantic scores, for example, Iₛ−5>Iₛ−4>Iₛ−2>Iₛ−3>Iₛ−1. Further in an example, consider that the percentage is defined as X=20%. Such a scale of percentage indicates to remove the instruction semantic IE ‘Iₛ−1’, as this instruction semantic IE falls below 20%. In another example, consider that the threshold is defined as Z=0.4. In such a case, the instruction semantic IEs ‘Iₛ−1’ and ‘Iₛ−3’ have been removed since the semantic scores of these instruction semantic IEs fall below the threshold (i.e., 0.4).

For example, consider that ‘Iᵢᵣᵣ⊆I’ be a set of identified irrelevant instruction semantic IEs. In such a scenario, a set of relevant/surviving instruction semantic IEs (Iᵣₑₗ) may be obtained as:

$${I}_{rel} = I / {I}_{rr}$$

After identifying the irrelevant instruction semantic IEs, there may exist a cluster formed. In some examples, the cluster may include the surviving instruction semantic IEs and the irrelevant contextual IEs. The irrelevant IE detection module 704 may identify the irrelevant contextual IEs within the cluster.

For identifying the irrelevant contextual IEs, the irrelevant IE detection module 704 may identify a maximum semantic proximity value of each of the original contextual IEs with each of the surviving instruction semantic IEs and others of the contextual IEs present in the cluster.

The maximum semantic proximity value of an original contextual IE with respect to a surviving instruction semantic IE may represent how strong or weak a semantic proximity/connection between the original contextual IE and the surviving instruction semantic IE. The maximum semantic proximity value of the original contextual IE with respect to the surviving instruction semantic IE may be determined based on the semantic structural proximity value of each of the original contextual IEs. In some examples, the maximum semantic proximity of the original contextual IE with respect to the surviving instruction semantic IE (maxSeml(s)) may be identified as:

$$max SemI ( s ) = SemStr ( s , i ) be the maximum such that ∀ {i}^{′} ∈ {I}_{rel} : SemStr ( s , i ) \geq SemStr ( s , {i}^{′} )$$

The maximum semantic proximity value of the original contextual IE with respect to other contextual IE may represent how strong or weak a semantic proximity/connection between the two contextual IEs. In some examples, the maximum semantic proximity of the original contextual IE with respect to the other contextual IE may be identified as:

$$max SemC ( s ) = Sem ( s , x ) be the maximum such that ∀ {s}^{′} ∈ C : Sem ( s , x ) \geq Sem ( s , {s}^{′} )$$

Further, the irrelevant IE detection module 704 may identify the irrelevant contextual IEs based on the maximum semantic proximity value of each original contextual IE and the second predetermined criteria. The second predetermined criteria may provide an instruction threshold (δIᵣₑₗ) and a contextual threshold (δ_{C}). In some examples, the instruction threshold (δIᵣₑₗ)) and the contextual threshold (δ_{C}) may set in accordance with the operating environment. For instance, the instruction threshold (δIᵣₑₗ) and the contextual threshold (δ_{C}) may set with default values of 0.7 and 0.5 respectively, in accordance with the operating environment. In some examples, the instruction threshold (δIᵣₑₗ) and the contextual threshold (δ_{C}) may set using Likert Scale such as high (≥0.8), moderate (>0.4 and <0.8) and low (≤4).

The irrelevant IE detection module 704 may identify some of the original contextual IEs as the irrelevant contextual IEs, when maximum semantic proximity values of the original contextual IEs with respect to the surviving instruction semantic IEs are below the instruction threshold (δIᵣₑₗ) and/or maximum semantic proximity values of the original contextual IEs with respect to other contextual IEs are below the contextual threshold (δ_{C}) (i.e., maxSeml(s)<δIᵣₑₗ AND maxSemC(s)<δ_{C}). Upon identifying the irrelevant contextual IEs, the irrelevant IE detection module 704 may include/add the respective contextual IEs to a set of irrelevant contextual IEs (Cᵢᵣᵣ) and removes from the cluster.

Alternatively, the irrelevant IE detection module 704 may identify some of the original contextual IEs as the relevant contextual IEs, if the contextual IEs are strongly connected with one or more of the relevant surviving instruction semantic IEs in Iᵣₑₗ (i.e., (maxSeml(s)≥δIᵣₑₗ)). Upon identifying the relevant contextual IEs, the irrelevant IE detection module 704 may include/add the contextual IEs to a set of relevant contextual IEs (Cᵣₑₗ) and remove from the cluster.

The irrelevant IE detection module may apply a chain rule to iteratively identify whether each of the contextual IEs present in the cluster are relevant or not, by analyzing whether the contextual IEs within the cluster are strongly connected with each other and are strongly related with any of the relevant surviving instruction semantic IEs.

For example, if the contextual IE is strongly connected with one of the other contextual IE, that is there may exist: s′∈Cᵣₑₗ such that Sem(s, s′)≥δ_{C}. In such a scenario, the contextual IE may be added to the set of relevant contextual elements Cᵣₑₗ. If the contextual IE is weakly connected with all the other relevant contextual IEs, that is there may exist: s′∈Cᵣₑₗ:Sem(s, s′)<δ_{C}. In such a scenario, the contextual IE may be added to the irrelevant set of relevant contextual IEs (Cᵣₑₗ).

The irrelevant instruction semantic IEs, the relevant instruction semantic IEs the set of irrelevant contextual IEs, and the set of relevant contextual IEs (as identified above) may be removed from the text prompt and the revised text prompt for the GAI system 202 may be generated (as described in FIG. 2).

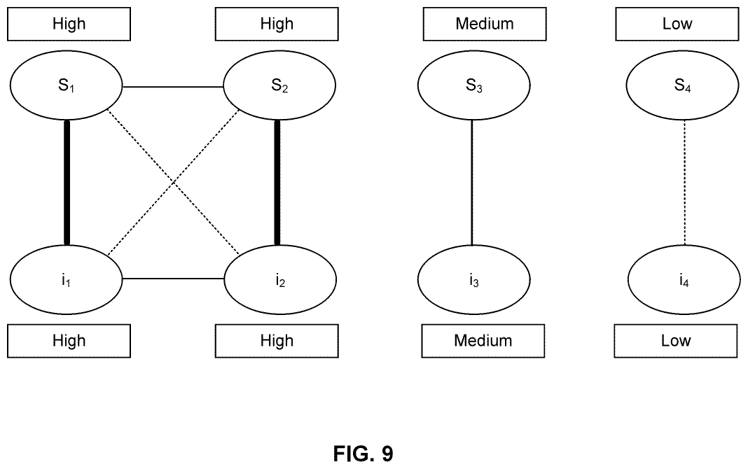

An example of processing the text prompt is described in detail below in conjunction with FIGS. 8, 9, and 10.

Consider an example text prompt received for processing: “I am into testing and we need to run our servers on low power budget for our current project involving web application. Pls tell me how can we reduce the energy overhead of testing? Also, once the project is over, we are expecting a very large project involving thousands of webpages to be tested on various platforms. May I know what leads to energy inefficiency of large-scale projects? We also need to prepare a detailed report on how we can use LLMs for our reporting purposes and I wonder how are they able to write such long answers. After I complete this task, I need to pay overdue bill and then go to Tmera with David for planning upcoming vacation.”

In such a scenario, the text prompt may be semantically segmented into following different types of text IEs:
s₁: I am into testing and we need to run our servers on low power budget for our current project involving web application.
i₁: Pls tell me how can we reduce the energy overhead of testing?
s₂: Also, once the project is over, we are expecting a very large project involving thousands of webpages to be tested on various platforms.
i₂: May I know what leads to energy inefficiency of large-scale projects?
s₃: We also need to prepare a detailed report on how we can use LLMs for our reporting purposes.
i₃: I wonder how are they able to write such long answers.
s₄: After I complete this task, I need to pay overdue bill and then go to Tmera with David for planning upcoming vacation.
i₄: Where should we go?

After semantically segmenting the text prompt into the text IEs (i.e., i₁, i₂ . . . i₄), the semantic proximity value among the text IEs may be determined (as described above). In an example herein, among the four text IEs, the text IEs i₁ and i₂ are more semantically proximate (i.e., having identical meaning) than the text IEs i₃, and i₄, as depicted in FIG. 8. Thereafter, the internal consistency value may be determined for each of the text IEs that include the instruction semantic IEs.

The semantic proximate value among the text IEs and the internal consistency of each of the text IEs may be used to determine the semantic relevance score for each of the text IEs (as described above). The semantic relevance score for each of the text IEs may be compared with the pre-defined threshold Z, which may be set as high, moderate, and low. In an example herein, as depicted in FIG. 9, based upon the comparison, it may be identified that the text IEs i₁ and i₂ fall into “high” threshold, the text IE i₃ may fall into “moderate” threshold, and the text IE i₄ may fall into “low” threshold. Therefore, the text IEs i₁ and i₂ are semantically proximate to each other and consistent.

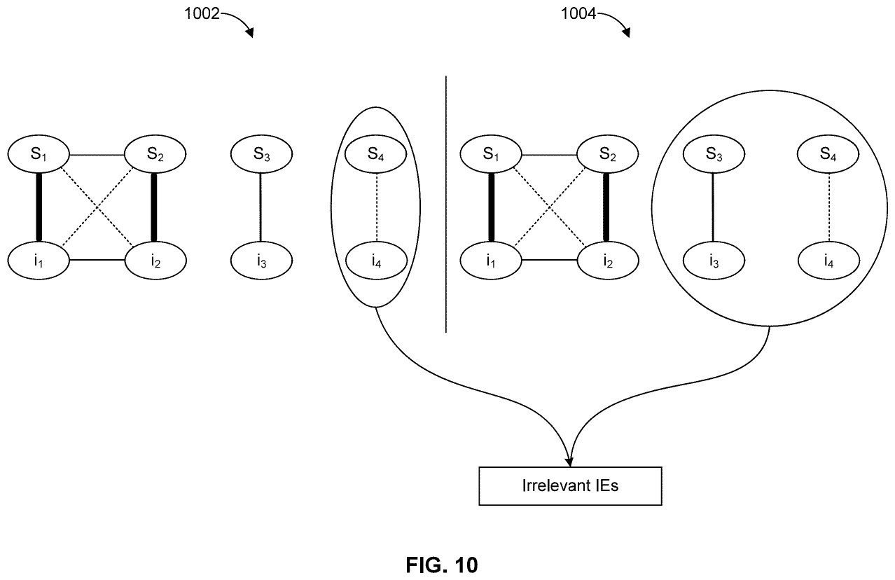

Further, as depicted in FIG. 10, if the threshold Z for removal of the irrelevant text IEs (as described in detail in conjunction with above FIG. 7) is pre-defined as “moderate” (1002), then the text IEs i₁, i₂, and i₃ fall under the high and moderate threshold are considered as the relevant text IEs and the text IE i₄ falls under the low threshold may be identified as the irrelevant text IE. In such a scenario, the text prompt may be revised by removing the text IE i₄. For example, the text prompt may be revised as: “I am into testing and we need to run our servers on low power budget for our current project involving web application. Pls tell me how can we reduce the energy overhead of testing? Also, once the project is over, we are expecting a very large project involving thousands of webpages to be tested on various platforms. May I know what leads to energy inefficiency of large-scale projects? We also need to prepare a detailed report on how we can use LLMs for our reporting purposes and I wonder how are they able to write such long answers.”

If the threshold Z is pre-defined as “low” (1004), then the text IEs i₁ and i₂ fall under the high threshold are considered as the relevant text IEs and the text IEs i₃, and i₄ are considered as the irrelevant text IEs. In such a scenario, the text prompt may be revised by removing the text IEs i₃, and i₄. For example, the text prompt may be revised as “I am into testing and we need to run our servers on low power budget for our current project involving web application. Pls tell me how can we reduce the energy overhead of testing? Also, once the project is over, we are expecting a very large project involving thousands of webpages to be tested on various platforms. May I know what leads to energy inefficiency of large-scale projects?”.

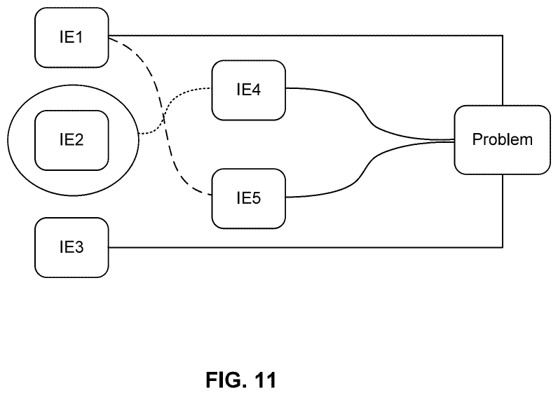

FIG. 11 depicts an example illustration of identifying irrelevant IEs in a text prompt in accordance with implementations of the present disclosure. In an example, as depicted in FIG. 11, the text prompt includes 5 IEs: an IE1, an IE2 and IE3, IE4, and IE5 and a problem. The text prompt may be represented as:

$$text prompt = IE 1 ... . IE 5 , prompt$$

In an example herein, the IE1 and the IE5 are semantically related and the IE2 and the IE4 are semantically related. However, the IE2 may not be related to the problem. Therefore, the IE2 may be the irrelevant text IE in the text prompt, since the IE2 is inconsistent in the text prompt.

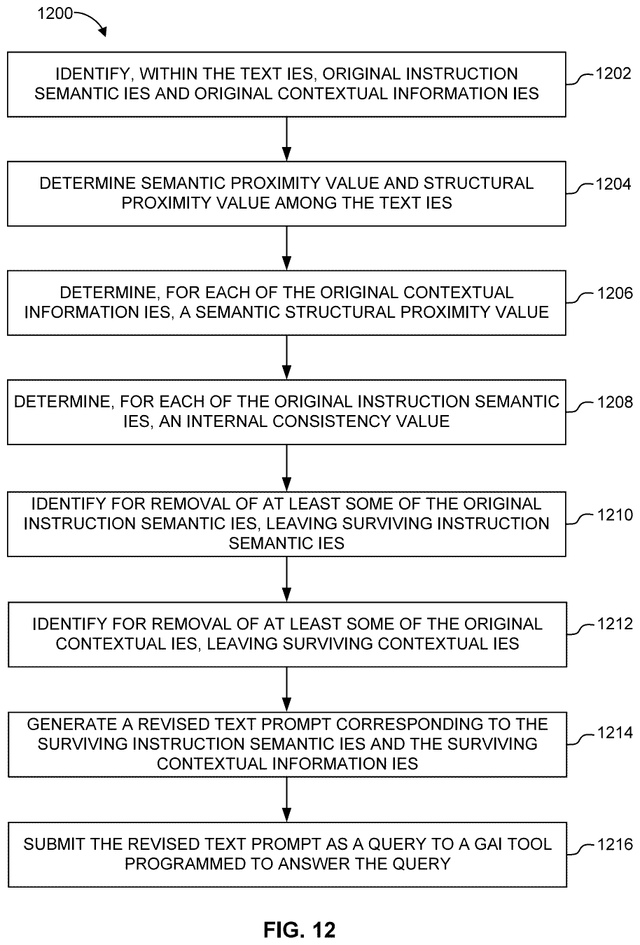

FIG. 12 is a flow diagram that presents an example method 1200 for processing a text prompt including text IEs in accordance with implementations of the present disclosure. In some implementations, the method 1110 may be executed within the processing system 114 as described in relation to FIGS. 2 and 3.

At step 1202, original instruction semantic IEs and original contextual IEs are identified within the text IEs. The original instruction semantic IEs and the original contextual IEs in the text prompt may be identified, by way of non-limiting example, using NLP techniques as known in the art and not further discussed herein. The original instruction semantic IEs and original contextual IEs may be identified using the element identifier 216 with reference to FIGS. 2 and 4.

At step 1204, semantic proximity value and structural proximity value among the text IEs are determined. The semantic proximity value represents the closeness of meaning between two text IEs. The structural proximity value among the text IEs represents how physically close two text IEs are in the text prompt.

At step 1206, a semantic structural proximity value of each of the original contextual IEs is determined with respect to each of the original instruction semantic IEs. The semantic structural proximity value of each original contextual IE may be determined based on the semantic proximity value and structural proximity value between each of the original contextual IEs and each of the original instruction semantic IEs. The semantic proximity value and structural proximity value among the text IEs, and the semantic structural proximity value of each original contextual IE may be determined using the proximity detector 218 with reference to FIGS. 2 and 5.

At step 1208, an internal consistency value is determined for each of the original instruction semantic IEs. The internal consistency value of a particular IE may be based on semantic proximities among constituent word pairs within the particular IE. The internal consistency may be determined using the consistency detector 220 with reference to FIGS. 2 and 6.

At step 1210, at least some of the original instruction semantic IEs may be identified for removal from the text prompt, leaving surviving instruction semantic IEs. At least some of the original instruction semantic IEs for removal may be identified based on the semantic proximity values and the internal consistency values relative to first predefined criteria, leaving surviving instruction semantic IEs.

At step 1212, at least some of the original contextual IEs may be identified for removal from the text prompt, due to weak connections with the surviving instructions semantic IEs and others of the contextual IEs based on second predetermined criteria, leaving surviving contextual IEs. At least some of the original instruction semantic IEs and contextual IEs may be identified for removal using the element remover 222 with reference to FIGS. 2 and 7.

At step 1214, a revised text prompt is generated by removing at least some of the identified original instruction semantic IEs and/or original contextual IEs (i.e., irrelevant text IEs) from the original text prompt. Therefore, the revised text prompt corresponds to the surviving instruction semantic IEs and the surviving contextual IEs.

At step 1216, the revised text prompt is submitted as a query to the GAI system 202 programmed to answer the query. Since the revised text prompt is shorter than the original text due to removal of the irrelevant text IEs, the GAI system consumes less power and computer resources to process the revised text prompt compared to higher power requirements and computer recourses needed to process the longer original text prompt. The methodology also reduces the probability of resubmission of the text prompt due to an insufficient answer, thus avoiding the power consumption of the extra (re) processing.

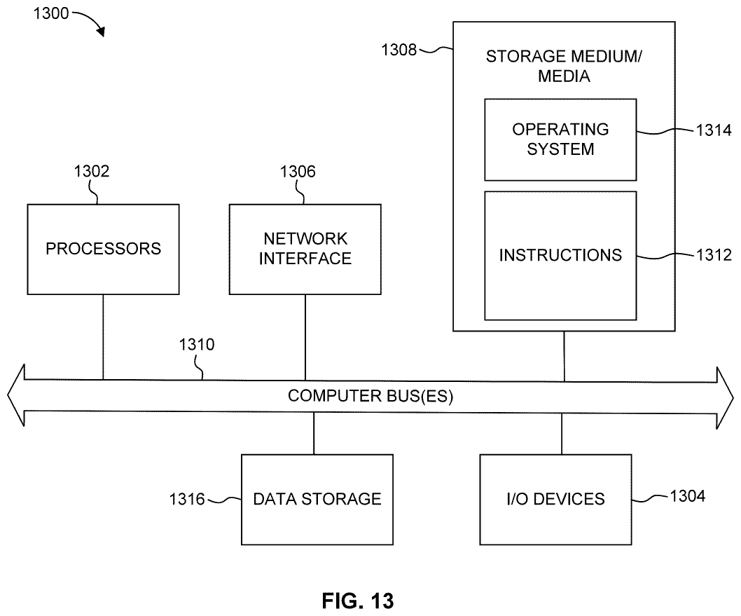

FIG. 13 illustrates a computer system 1300 that may be used to implement the processing system 114. More particularly, computing machines such as desktops, laptops, smartphones, tablets, and wearables which may be used to process the text prompt in the processing system 114 may have the structure of the computer system 1300. The computer system 1300 may include additional components not shown and that some of the process components described may be removed and/or modified. In another example, a computer system 1300 may be deployed on external-cloud platforms such as cloud, internal corporate cloud computing clusters, organizational computing resources, and/or the like.

The computer system 1300 includes processor(s) 1302, such as a central processing unit, ASIC or another type of processing circuit, input/output devices 1304, such as a display, mouse keyboard, etc., a network interface 1306, such as a Local Area Network (LAN), a wireless 802.11x LAN, a 3G or 4G mobile WAN or a WiMax WAN, and a processor-readable medium 1308. Each of these components may be operatively coupled to a bus 1310. The computer-readable medium 1308 may be any suitable medium that participates in providing instructions to the processor(s) 802 for execution. For example, the computer-readable medium 1308 may be non-transitory or non-volatile medium, such as a magnetic disk or solid-state non-volatile memory or volatile medium such as RAM. The instructions or modules stored on the computer-readable medium 1308 may include machine-readable instructions 1312 executed by the processor(s) 1302 that cause the processor(s) 1302 to perform the methods and functions of the processing system 114.

The processing system 114 may be implemented as software stored on a non-transitory processor-readable medium and executed by the processors 1302. For example, the computer-readable medium 1308 may store an operating system 1314, such as MAC OS, MS WINDOWS, UNIX, or LINUX, and code 808 for the processing system 114. The operating system 1314 may be multi-user, multiprocessing, multitasking, multithreading, real-time, and the like. For example, during runtime, the operating system 1314 is running and the code for the processing system 114 is executed by the processor(s) 1302.

The computer system 1300 may include a data storage 1316, which may include non-volatile data storage. The data storage 1316 stores any data used or generated by the processing system 114.

The network interface 1306 connects the computer system 1300 to internal systems for example, via a LAN. Also, the network interface 1306 may connect the computer system 1300 to the Internet. For example, the computer system 1300 may connect to web browsers and other external applications and systems via the network interface 1306.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations of the present disclosure provide multiple technical improvements and address drawbacks of traditional chatbots and integration of a GAI system, such as those discussed herein. For example, implementations of the present disclosure reduce cost of processing a text prompt and generating a response for the text prompt. Such a cost reduction may directly lead to reduced climate impact of GAI system. Further, as GAI based applications are increasingly getting wide scale adoption, such cost reduction may result in increasing sustainability of the GAI based applications and their operating environments.

Implementations of the present disclosure enable identification and removal of irrelevant details/IEs from the text prompt without requiring any knowledge of the type of the irrelevant details. Thereby, generating the refined text prompt. Further, the refined text prompt may be sent to the foundation models/LLMs of the GAI system, which may provide effectiveness in processing the text prompt by the foundation models by decreasing a number of iterations required to obtain an expected response. Thereby, an accurate/precise response may be generated with less cost.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for processing a text prompt including a set of text Information Elements (IEs), comprising:
identifying, by one or more processors, within the text IEs, original instruction semantic IEs and original contextual IEs;
determining, by the one or more processors, semantic proximity value and structural proximity value among the text IEs;
determining, by the one or more processors, for each of the original contextual IEs, a semantic structural proximity value with each of the original instruction semantic IEs based on the semantic proximity value and structural proximity value between each of the original contextual IEs and each of the original instruction semantic IEs;
determining, by the one or more processors, for each of the original instruction semantic IEs, an internal consistency value;
identifying, by the one or more processors, for removal of at least some of the original instruction semantic IEs based on semantic proximity values and internal consistency values relative to first predefined criteria, leaving surviving instruction semantic IEs;
identifying, by the one or more processors, for removal of at least some of the original contextual IEs due to weak connections with the surviving instructions semantic IEs and others of the contextual IEs based on second predefined criteria, leaving surviving contextual IEs;
generating, by the one or more processors, a revised text prompt corresponding to the surviving instruction semantic IEs and the surviving contextual IEs; and
submitting, by the one or more processors, the revised text prompt as a query to a Generative Artificial Intelligence (GAI) system programmed to answer the query.

2. The method of claim 1, wherein each text IE is a sentence of the text prompt.

3. The method of claim 1, wherein the semantic proximity value represents closeness of meaning between two text IEs within the text prompt.

4. The method of claim 1, wherein the structural proximity value represents physical proximity between the two text IEs within the text prompt.

5. The method of claim 1, wherein the semantic structural proximity value between two text IEs is a weighted combination of the semantic proximity value and the structural proximity value between the two text IEs.

6. The method of claim 1, wherein the first predetermined criteria include a predefined percentage, wherein original instruction semantic IEs as ordered below the predefined percentage based on the semantic proximity values and the internal consistency values are identified for the removal.

7. The method of claim 1, wherein the internal consistency value of a particular IE is based on semantic proximities among constituent word pairs within the particular IE.

8. A non-transitory computer readable media storing instructions to cause a processor to perform operations for processing a text prompt including a set of text Information Elements (IEs), the operations comprising:
identifying within the text IEs, original instruction semantic IEs and original contextual IEs;
determining semantic proximity value and structural proximity value among the text IEs; determining for each of the original contextual IEs, a semantic structural proximity value with each of the original instruction semantic IEs based on the semantic proximity value and structural proximity value between each of the original contextual IEs and each of the original instruction semantic IEs;
determining for each of the original instruction semantic IEs, an internal consistency value; identifying for removal of at least some of the original instruction semantic IEs based on the semantic proximity values and internal consistency values relative to first predefined criteria, leaving surviving instruction semantic IEs;
identifying for removal of at least some of the original contextual IEs due to weak connections with the surviving instructions semantic IEs and others of the contextual IEs based on second predetermined criteria, leaving surviving contextual IEs;
generating a revised text prompt corresponding to the surviving instruction semantic IEs and the surviving contextual IEs; and
submitting the revised text prompt as a query to a Generative Artificial Intelligence (GAI) system programmed to answer the query.

9. The non-transitory computer readable media of claim 8, wherein each text information element is a sentence of the prompt.

10. The non-transitory computer readable media of claim 8, wherein the semantic proximity value represents closeness of meaning between two text IEs within the text prompt.

11. The non-transitory computer readable media of claim 8, wherein the structural proximity value represents physical proximity between the two text IEs within the text prompt.

12. The non-transitory computer readable media of claim 8, wherein the semantic structural proximity value between two text IEs is a weighted combination of the semantic proximity value and the structural proximity value between the two text IEs.

13. The non-transitory computer readable media of claim 8, wherein the first predetermined criteria include a predefined percentage, wherein original instruction semantic IEs as ordered below the predefined percentage based on the semantic proximity values and the internal consistency values are identified for the removal.

14. The non-transitory computer readable media of claim 8, wherein the internal consistency value of a particular IE is based on semantic proximities among constituent word pairs within the particular IE.

15. A system for processing a text prompt including a set of text Information Elements (IEs), comprising:
a non-transitory computer readable media storing instructions; and
a processor programmed to cooperate with the instructions in memory to cause the processor to perform operations including:
identifying within the text IEs, original instruction semantic IEs and original contextual IEs;
determining semantic proximity value and structural proximity value among the text IEs;
determining for each of the original contextual IEs, a semantic structural proximity value with each of the original instruction semantic IEs based on the semantic proximity value and structural proximity value between each of the original contextual IEs and each of the original instruction semantic IEs;
determining for each of the original instruction semantic IEs, an internal consistency value;
identifying for removal of at least some of the original instruction semantic IEs based on the semantic proximity values and internal consistency values relative to first predefined criteria, leaving surviving instruction semantic IEs;
identifying for removal of at least some of the original contextual IEs due to weak connections with the surviving instructions semantic IEs and others of the contextual IEs based on second predetermined criteria, leaving surviving contextual IEs;
generating a revised text prompt corresponding to the surviving instruction semantic IEs and the surviving contextual IEs; and
submitting the revised text prompt as a query to a Generative Artificial Intelligence (GAI) system programmed to answer the query.

16. The system of claim 15, wherein each text information element is a sentence of the prompt.

17. The system of claim 15, wherein the semantic proximity value represents closeness of meaning between two text IEs within the text prompt.

18. The system of claim 15, wherein the semantic proximity value represents closeness of meaning between two text IEs within the text prompt.

19. The system of claim 15, wherein the semantic structural proximity value between two text IEs is a weighted combination of the semantic proximity value and the structural proximity value between the two text IEs.

20. The system of claim 15, wherein the first predetermined criteria include a predefined percentage, wherein original instruction semantic IEs as ordered below the predefined percentage based on the semantic proximity values and the internal consistency values are identified for the removal.
